(19) United States
(12) Patent Application Publication
(10) Pub. No.: US 2007/0175210 A1
(43) Pub. Date: Aug. 2, 2007

(54) Control and adjustment system for a lifting and tilting mechanism of a working tool in a mobile machine

(76) Inventors: Jochen Beck, Elchingen (DE); Dieter Roth, Schluechetern (DE); Ulrich Heinz, Elchingen (DE)

Correspondence Address: SCULLY, SCOTT, MURPHY & PRESSER, P.C., 400 GARDEN CITY PLAZA, SUITE 300, GARDEN CITY, NY, 11530, US

(21) Appl. No.: 10/564,690

(22) PCT Filed: May 19, 2004
(86) PCT No.: PCT/EP04/05437

§ 371 Date: Feb. 23, 2007

(30) Foreign Application Priority Data
Jul. 11, 2003 (DE) 10331533.0

(51) Int. Cl. F16D 31/02

(52) U.S. Cl. 60/464; 91/461

(57) ABSTRACT

The invention relates to a control and adjustment system for a lifting mechanism (100) of a loading blade (6) in a mobile machine tool. Said lifting mechanism is made up of at least one first and second blade cylinder (1, 2), at least one first and second lifting cylinder (61, 62) and one first and second hydropump (15, 75) which can be adjusted with regard to the pump volume. The adjusting pistons (3, 5) which can be displaced in the first and second blade cylinders (1, 2), respectively, separate both blade cylinders (1, 2) into two adjusting pressure chambers (7 and 8, 9 and 10). The adjusting pistons (63, 65) which can be displaced in the two lifting cylinders (61, 62) respectively separate the two lifting cylinders (61, 62) into the two adjusting pressure chambers (67 and 68, 69 and 70) in an analogous manner. In a first closed hydraulic circuit, a first and the second connection (14, 17) of the first hydropump (15) is, respectively made to the piston side of the piston pressure chamber (7, 9) of one blade cylinder (1, 2) and to the piston rod side of the adjusting pressure chamber (10, 8) of the other blade cylinder (2, 1). The first and second connection (74, 77) of the second hydropump (75) is respectively made in a second closed hydraulic circuit to a piston side adjusting pressure chamber (70, 67) of a lifting cylinder (62, 61) and to the piston rod side of the adjusting pressure chamber (68, 69) of the other lifting cylinder (61, 62).

The invention relates to a control and adjustment system for a lifting and tilting mechanism of a working tool in a mobile machine.

The working hydraulics in mobile machines with a shovel-shaped working tool—for example in wheeled loaders, diggers and fork lift trucks—consist of a lifting mechanism and a tilting mechanism. The lifting mechanism consists of a boom located between the vehicle body and the working tool, which is hydraulically driven by two lifting cylinders and lifts or lowers the working tool depending on the direction of swivel by a swivelling movement relative to the vehicle body. The tilting mechanism has one or two shovelling cylinders which are mounted between the vehicle body and the shovel-shaped working tool and drive the shovelling tool to an outwards-tilting or an inwards-tilting tilting movement depending on the tilting direction.

A hydraulic control device for working hydraulics of this kind is illustrated in EP 0 564 939 B1. The two lifting and shovelling cylinders are switched parallel in each case. The position and direction of movement of the adjusting pistons in the lifting cylinders fix the lifting height and the vertical direction of movement of the loading shovel relative to the vehicle body. Analogously, the tilting angle and the tilting direction of the loading shovel are fixed by the position and direction of movement of the adjusting piston in the shovelling cylinders. The position and direction of movement of the adjusting piston in the lifting or shovelling cylinder are fixed by the difference in pressure between the piston side and the piston rod side adjusting pressure chambers. Supplying the piston side and piston rod side adjusting pressure chambers in the individual lifting and shovelling cylinders with hydraulic fluid of a specific adjusting pressure is done by a common hydraulic pump regulating the pressure and the discharge stream.

As this is a hydraulic pump operating in single-quadrant operation, the switchover of the adjusting pressure differences between the piston side and the piston rod side adjusting pressure chambers of the lifting and shovelling cylinders is implemented via control valves in a control block in the hydraulic load circuit between the hydraulic pump and the lifting and shovelling cylinders. Each of these control valves—one control valve each for the lifting mechanism and the tilting mechanism—is actuated via a pilot control device to which a steering instrument, for example, a steering wheel or joystick, is attached, as a function of the desired reference values—lifting height, tilting angle, vertical direction of movement and tilting direction.

Metering of the stream of hydraulic fluid from the hydraulic pump to the individual lifting and shovelling cylinders depending on load is implemented via intermediate switching of a control valve (priority valve).

This hydraulic actuation of the lifting and shovelling cylinders has a series of disadvantages.

The adjusting energy level for the hydraulic lifting mechanism is in a completely different order of magnitude from the adjusting energy level for the hydraulic tilting mechanism (lifting mechanism: approximately 150 to 180 bar, tilting mechanism: approximately 20 to 50 bar). As a single hydraulic pump, the maximum discharge volume of which is configured to the hydraulic volume required by the lifting mechanism, is used for the lifting and tilting mechanisms, in the case of hydraulic actuation of the tilting mechanism a not unappreciable hydraulic loss of energy results. This hydraulic loss of energy generates heat which unnecessarily decreases the hydraulic efficiency of the working hydraulics and has to be additionally removed.

The circuitry of the stream of hydraulic fluid from the hydraulic pump to the correct adjusting pressure chambers of the lifting and shovelling cylinders according to the desired theoretical values of the working hydraulics—lifting height, tilting angle, vertical direction of movement and tilting direction—can be produced on the basis of single-quadrant operation of the hydraulic pump only via expensive control valves in control blocks. The configuration of the control valves in terms of control engineering (e.g. parameterisation of the fine control grooves in the control valve) is very difficult to configure. Additionally, with control blocks there is a considerable outlay on pipework and screw fittings, which represents an additional risk of oil leakage sites. The control blocks including the additional pipework and screw fittings cause additional space requirement. The outlay for assembly, maintenance and servicing increases owing to the greater complexity of the system. Owing to their adjustable flow cross-section, the control valves lead to higher through-flow resistances in the hydraulic load circuit by comparison with a normal hydraulic load line between the hydraulic pump and the hydraulic cylinder. Flow cross-sections in the load circuit cause unnecessary hydraulic losses which unnecessarily decrease the efficiency of the working hydraulics of this kind.

The object of the invention is therefore to further develop the hydraulic control and adjustment system for a lifting mechanism and a tilting mechanism of a working tool in a mobile machine according to the preamble of claim 1 and claim 6 in such a way that the adjusting pressures required for the desired theoretical values of the working hydraulics—lifting height, tilting angle, vertical direction of movement and tilting direction—in the two adjusting pressure chambers of the lifting and shovelling cylinders are conducted from an adjustable hydraulic pump, directly without intermediate switching of additional control and adjusting devices, such as, for example, control valves in control blocks, into the respective adjusting pressure chambers.

The object of the invention is achieved by a hydraulic control and adjustment system for a lifting mechanism or a tilting mechanism of a working tool in a mobile machine with the features of claim 1 or claim 6.

An essential feature of the hydraulic control and adjustment system according to claim 1 and claim 6, distinguishing it from the apparatus in EP 0 564 939 B1, in which an open hydraulic circuit course is used, is the use of a closed circuit between the hydraulic pump and the respective hydraulic consumer (lifting cylinder of the lifting mechanism and shovelling cylinder of the tilting mechanism). This presupposes that the discharge volume transported from the hydraulic pump to the hydraulic consumer corresponds to the discharge volume transported back from the hydraulic consumer to the hydraulic pump.

In a closed hydraulic circuit, by contrast with an open hydraulic circuit, no vacuum can arise in the adjusting pressure chambers connected to the low pressure side connection of the hydraulic pump on transition from expansion to compression. The cavitations occurring when there is a vacuum in the cylinders, which can lead to damage to the cylinders, do not occur in this case.

In a closed hydraulic circuit the use of a hydraulic pump operating in two-quadrant operation is possible. In this way, by adjusting the hydraulic pump in respect of the direction of current and the adjusting pressure levels applied at its two connections, any given difference in adjusting pressure for the two adjusting pressure chambers of the lifting or shovelling cylinders can be generated. Expensive intermediate switching of control blocks with control valves for generating any given adjusting pressure differences in the two adjusting pressure chambers of the lifting or shovelling cylinders from the unidirectional adjusting pressure difference at the two connections of the hydraulic pump is thus not necessary. The adjusting pressure difference between the two connections of the hydraulic pump can be set in respect of their polarity and their level by an adjusting device anywhere within the implementable adjusting range of the hydraulic pump. Adjustment of the necessary adjusting pressure differences is therefore relocated in this arrangement from the load circuit to the control circuit of the hydraulic pump.

The hydraulic control and adjusting apparatus according to the invention for a lifting or tilting mechanism of a working tool in a mobile machine consequently no longer has the above-mentioned disadvantages—additional outlay on pipework and screw fittings, increased space requirement, additional oil leakage sites, increased assembly, maintenance and servicing outlay, smaller through-flow resistances in the load circuit and above all higher system costs.

Advantageous, in particular detailed, configurations of the invention are cited in the dependent claims.

A parallel circuit of the two lifting and/or shovelling cylinders as in EP 0 564 939 B1 is eliminated on the basis of the different compression or expansion volumes in the piston side and the piston rod side adjusting pressure chambers when the adjusting piston is displaced.

It is therefore advantageous to connect the two lifting or shovelling cylinders in each case anti-parallel and thus to implement equal expansion and compression volumes over both lifting and shovelling cylinders together when the adjusting piston is displaced. Equal expansion and compression volumes on displacement of the adjusting piston in the adjusting pressure chambers of the lifting or shovelling cylinders guarantee equal discharge volumes in the forward and return lines for implementing a closed hydraulic circuit.

A separate hydraulic pump in each case is advantageous for implementing a closed hydraulic circuit for the lifting mechanism and the tilting mechanism. With this the adjusting pressure differences required for the adjusting pressure chambers of the lifting or shovelling cylinders can be set independently of one another by the respective adjusting devices of the two hydraulic pumps. There is no longer any mutual negative influencing of the lifting and tilting functions as with implementation by means of an open hydraulic circuit. Also, each hydraulic pump can be adapted to the capacity requirement of the lifting or tilting mechanism in respect of its discharge capacity. With an open hydraulic circuit the discharge capacity of the hydraulic pump has to be orientated to the requirement of the heaviest-duty consumer. In an open hydraulic circuit the tilting mechanism is consequently supplied with an excessively high hydraulic capacity, which can unnecessarily decrease the efficiency of the tilting mechanism.

Actuation of the adjusting valve for the adjusting device of the two hydraulic pumps can be done electrically or hydraulically.

In the case of hydraulic implementation a pilot control device is used which is actuated via a steering instrument, for example a joystick, in each case in a deflection dimension of the steering instrument for each hydraulic pump and therefore for each hydraulic function—lifting mechanism, tilting mechanism. The pilot control device generates at its outputs the adjusting pressure pairs required for the deflection of the adjusting valve piston corresponding to the deflection of the steering instrument.

In electrical actuation the mechanical deflection of the steering instrument is transformed via a transformer into an electric signal which is supplied to the electric adjusting magnets for deflection of the adjusting valve piston. The advantage of electric as opposed to hydraulic actuation is the low technical outlay—no pipework, screw fittings and hydraulic valves—and the small space requirement in particular in the driver's cab. A simple system integration of the electric actuation into existing control systems of the mobile machine—for example control for hydrostatic travel drive—represents a further advantage of electric actuation.

Connecting the piston side and piston rod side adjusting pressure chambers of the shovelling cylinders in the operating state “float position” of the mobile machine, in which the loading shovel carries out levelling of the plane without adjusting pressure simply on the basis of the loading shovel's own weight is comparatively easy for a closed hydraulic circuit to implement. Whereas in an open hydraulic circuit for this operating state a further adjusting valve in a control block has to be reserved for this, in a hydraulic control and adjustment system according to the invention the two hydraulic load lines are short-circuited via a simply executed 2/2 port directional control valve which can be actuated electrically or hydraulically.

In order to prevent dropping or tilting back of the working tool if one or both hydraulic pumps fail, electrically or hydraulically actuatable (switchable) check valves—so-called “low leak” valves—are used in one of the two hydraulic load lines to the lifting and shovelling cylinders.

To avoid undesired pitching of the working tool while the mobile machine is travelling a hydraulic control arrangement for damping the boom, as described for example in DE 41 29 509 C2, is used. This hydraulic control arrangement loads the shovelling cylinder by switching hydraulic buffer stores specifically to the expected load pressure, therefore leading to marked damping of the pitching oscillations of the working tool.

It is possible to dispense with anti-parallel circuitry of the two lifting or shovelling cylinders in favour of parallel circuitry, if an adjusting piston with a two-sided piston rod is used in the cylinders instead of a one-sided piston rod. On displacement of an adjusting piston of this kind in the cylinder the expansion and compression volume in the two adjusting pressure chambers, separated by the adjusting piston, is of equal size. Therefore the hydraulic fluid volume transported from the hydraulic pump to the hydraulic consumer—lifting or shovelling cylinder—corresponds to the hydraulic fluid volume transported from the hydraulic consumer back to the hydraulic pump, enabling implementation of a closed hydraulic circuit.

Three embodiments of the invention are illustrated in the drawings and described in greater detail below.

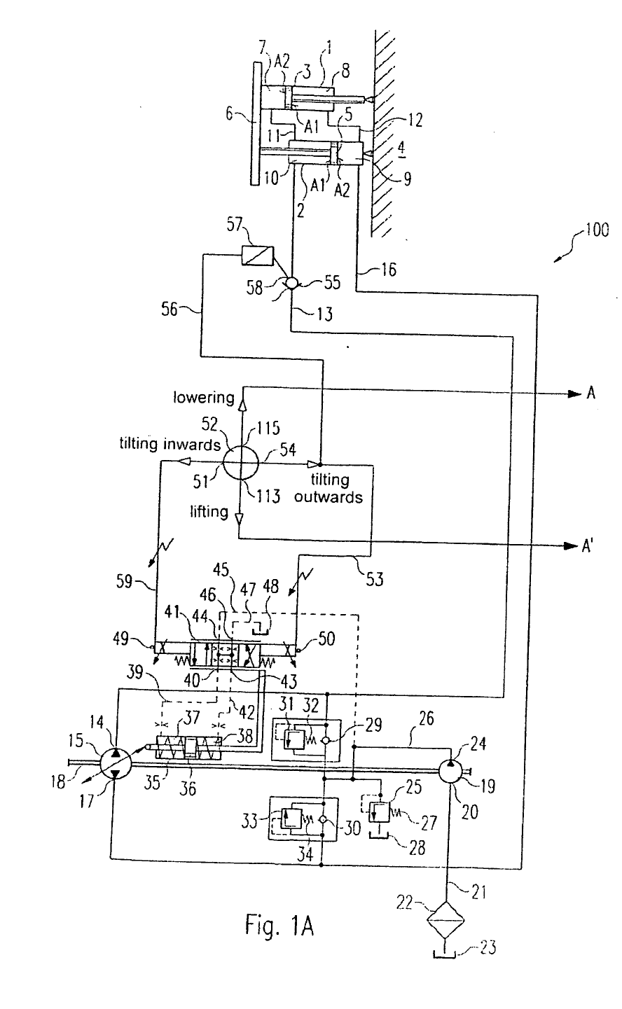

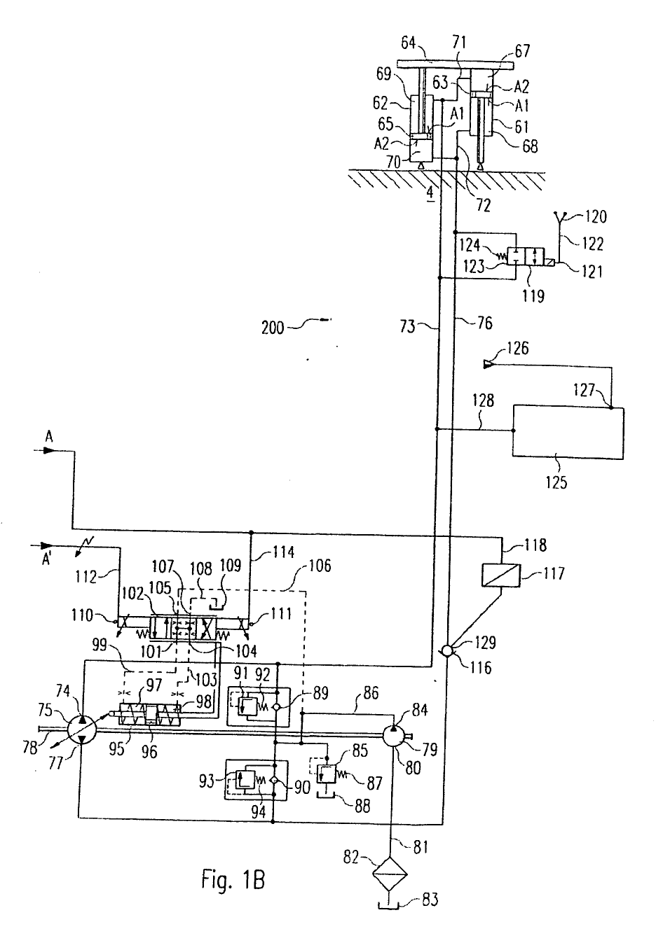

FIG. 1A shows a circuit diagram of a first embodiment example of a hydraulic control and adjustment system according to the invention for a working tool in a mobile machine with electric actuation of the adjusting valve (actuation of the tilting mechanism).

FIG. 1B shows a circuit diagram of a first embodiment example of a hydraulic control and adjustment system according to the invention for a working tool in a mobile machine with electric actuation of the adjusting valve (actuation of the lifting mechanism).

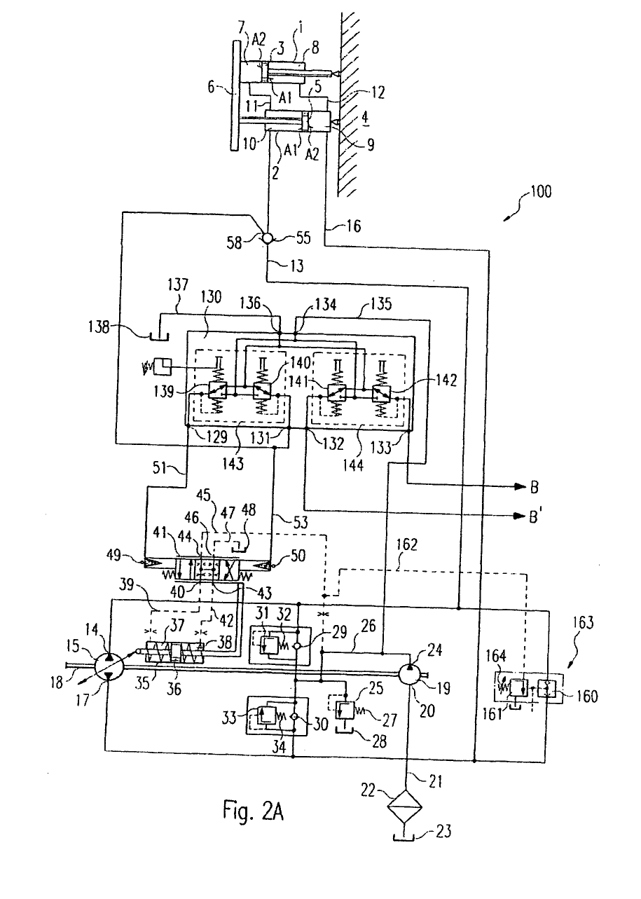

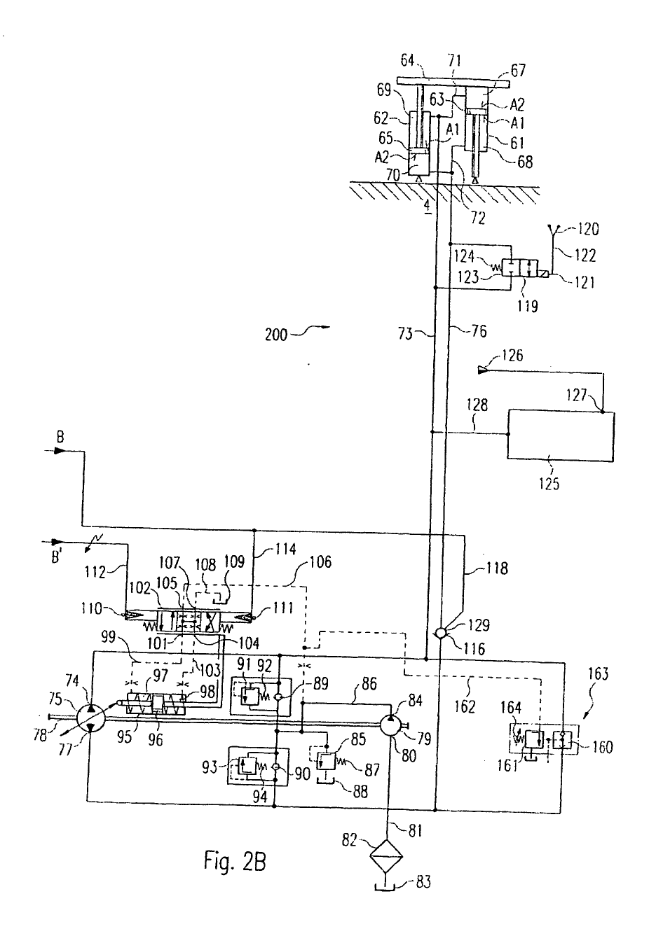

FIG. 2A shows a circuit diagram of a second embodiment example of a hydraulic control and adjustment system according to the invention for a working tool in a mobile machine with hydraulic actuation of the adjusting valve (actuation of the tilting mechanism).

FIG. 2B shows a circuit diagram of a second embodiment example of a hydraulic control and adjustment system according to the invention for a working tool in a mobile machine with hydraulic actuation of the adjusting valve (actuation of the lifting mechanism).

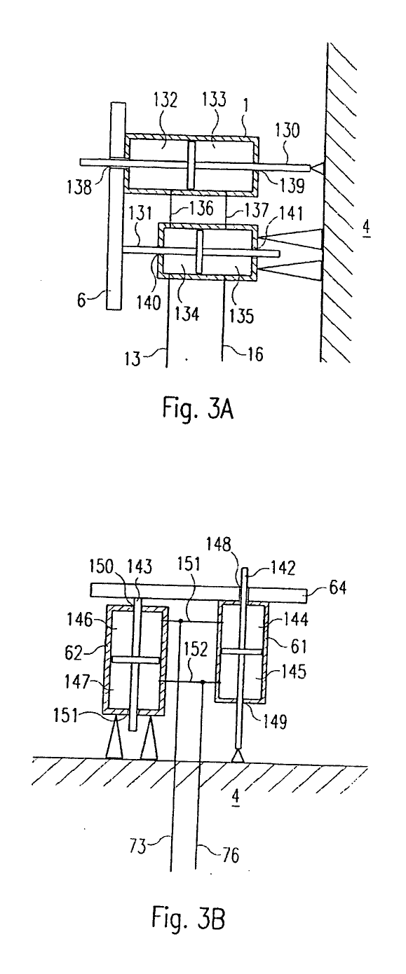

FIG. 3A shows a circuit diagram of the shovelling cylinder hydraulics of a third embodiment example of the hydraulic control and adjustment system according to the invention for a working tool in a mobile machine.

FIG. 3B shows a circuit diagram of the lifting cylinder hydraulics of a third embodiment example of the hydraulic control and adjustment system according to the invention for a working tool in a mobile machine.

The hydraulic control and adjustment system according to the invention for a working tool in a mobile machine is described below in two embodiment examples with reference to FIG. 1A to FIG. 3B.

In FIG. 1A a circuit diagram of a hydraulic control and adjustment system for a tilting mechanism 100 of a working tool in a mobile machine is illustrated, consisting of a first shovelling cylinder 1 and a second shovelling cylinder 2. In the first shovelling cylinder 1 an adjusting piston 3 is guided displaceably and mechanically coupled to the vehicle body 4. The first shovelling cylinder 1 is mechanically connected to the loading shovel 6, which can be deflected relative to the vehicle body 4 in respect of the tilting angle and the tilting direction. In the second shovelling cylinder 2 the adjusting piston 5 is guided displaceably and connected to the loading shovel 6. The second shovelling cylinder 2 is mechanically connected to the vehicle body 4.

The first shovelling cylinder 1 has a piston side adjusting pressure chamber 7 and a piston rod side adjusting pressure chamber 8. The second shovelling cylinder 2 likewise has a piston side adjusting pressure chamber 9 and a piston rod side adjusting pressure chamber 10. The piston side adjusting pressure chamber 7 of the first shovelling cylinder 1 is connected to the piston rod side adjusting pressure chamber 10 of the second shovelling cylinder 2 via a hydraulic line 11. In the same way the piston rod side adjusting pressure chamber 8 of the first shovelling cylinder 1 is connected to the piston side adjusting pressure chamber 9 of the second shovelling cylinder 2 via a hydraulic line 12.

The piston rod side adjusting pressure chamber 10 of the second shovelling cylinder 2 or the piston side adjusting pressure chamber 7 of the first shovelling cylinder 1 is connected to the first connection 14 of an adjustable first hydraulic pump 15 via a first hydraulic load line 13. The piston side adjusting pressure chamber 9 of the second shovelling cylinder 2 or the piston rod side adjusting pressure chamber 8 of the first shovelling cylinder 1 is connected to the second connection 17 of the adjustable first hydraulic pump 15 via a second hydraulic load line 16. The adjustable first hydraulic pump 15 is actuated via a drive shaft 18 of a drive motor (not illustrated in FIG. 1A), for example a diesel aggregate.

In each case a first adjusting pressure chamber 68, 69 borders on the associated cylinder piston 63, 65 with a pressurisation face A1, which is smaller than the pressurisation face A2 with which the other second adjusting pressure chamber 67, 70 in each case borders on the corresponding cylinder piston 63, 65. Each connection 74, 77 of the hydraulic pump 75 is connected to a first adjusting pressure chamber 68, 69 with a smaller pressurisation face A1 and a second adjusting pressure chamber 67, 70 with a larger pressurisation face A2.

A first feed pump 19 is likewise actuated via the drive shaft 18 by the drive motor. The first feed pump 19 is a hydraulic pump operating in single-quadrant operation, the low pressure side connection 20 of which is connected to a hydraulic tank 23 via a hydraulic line 21 with intermediate switching of a filter 22.

The high pressure side connection 24 of the first feed pump 19 is connected in respect of a pressure limitation to a pressure limiting valve 25 via a hydraulic line 26. One of the two control connections of the pressure limiting valve 25 is connected to the hydraulic line 26. At the other control input of the pressure limiting valve 25 a specific upper pressure limit value can be set via a spring 27. If the pressure in the hydraulic line 26 exceeds the upper pressure limit value set by the spring 27, the pressure limiting valve 25 opens and connects the hydraulic line 26 to the hydraulic tank 28. The pressure in the hydraulic line 26 thereupon reduces until a pressure corresponding to the upper pressure limit value ensues in the hydraulic line 26 and the pressure limiting valve 25 goes back into the closed state.

The high pressure side connection 24 of the first feed pump 19 is connected to a first check valve 29 and a second check valve 30 via the hydraulic line 26. The first check valve 29 is connected with its second connection to the first hydraulic load line 13, while check valve 30 is connected with its second connection to the second hydraulic load line 16. If the pressure in the first hydraulic load line 13 drops below the pressure level fixed in the hydraulic line 26 via the pressure limiting valve 25, check valve 29 opens and adapts the pressure in the first hydraulic load line 13 to the pressure prevailing in the hydraulic line 26. Completely analogously, if there is a drop in pressure in the second hydraulic load line 16 below the pressure level prevailing in hydraulic line 26, check valve 30 opens and adapts the pressure in the second hydraulic load line 16 to the pressure prevailing in the hydraulic line 26.

A pressure limiting valve 31 is switched parallel to check valve 29. This pressure limiting valve 31 compares the pressure value applied at one of its control inputs in the first hydraulic load line 13 with the theoretical pressure value set at the other control input via a spring 32 and opens if the pressure in the first hydraulic load line 13 exceeds the theoretical pressure value set by the spring 32. The pressure in the first hydraulic load line 13 is in this case reduced via the pressure limiting valve 31 into the hydraulic line 26 until the pressure in the first hydraulic load line 13 corresponds to the theoretical pressure value set by the spring 32 at the pressure limiting valve 31 and the pressure limiting valve 31 goes back into the closed state.

Analogously, a second pressure limiting valve 33 is switched parallel to check valve 30. This compares the pressure prevailing in the second hydraulic load line 16 and applied at one of its control inputs with a theoretical pressure value set at its other control input by a spring 34 and opens if the pressure in the second hydraulic load line 16 exceeds the theoretical pressure value set by the spring 34. The pressure in the second hydraulic load line 16 is in this case reduced in the hydraulic line 26 via the second pressure limiting valve 33 until the pressure in the second hydraulic load line 16 corresponds to the theoretical pressure value set by the spring 34 and the pressure limiting valve 33 goes back into the closed state.

Actuation of the adjustable first hydraulic pump 15 is done via a first adjusting device 35, the adjusting piston 36 of which is mechanically connected to the captive C-washer (not illustrated in FIG. 1) of the hydraulic pump 15. The adjusting piston 36 divides the first adjusting device 35 into a first adjusting pressure chamber 37 and a second adjusting pressure chamber 38. The first adjusting pressure chamber 37 is connected via a hydraulic line 39 to the first output 40 of an adjusting valve 41, configured as a 4/3 port directional control valve. The second adjusting pressure chamber 38 is connected to the second output 43 of the adjusting valve 41 via a hydraulic line 42. The first input 44 of the adjusting valve 41 is attached to the high pressure side connection 24 of the feed pump 19 via a hydraulic line 45 and hydraulic line 26. The second input 46 is connected to a hydraulic tank 48 via a hydraulic line 47.

Actuation of the adjusting valve 41 is done via a first control input 49 and a second control input 50, both designed as electric adjusting magnets. Via an electric line 51 the electric adjusting magnet of the first control input 49 is connected to a first output 51 of a transformer (not illustrated in FIG. 1A), which transforms the mechanical deflection on a steering instrument 52 configured as a joystick in the “tilting inwards” direction in the first deflection dimension determined for the tilting mechanism 100 into a first electric signal corresponding thereto. The electric adjusting magnet of the second control input 50 is connected via an electric line 53 to a second output 54 of the transformer (not illustrated in FIG. 1A), which transforms the mechanical deflection on the steering instrument 52 in the direction “tilting outwards” in the first deflection dimension determined for the tilting mechanism 100 into a second electric signal corresponding thereto.

If the vehicle driver intends to tilt the loading shovel 6 outwards, a deflection in the “tilting outwards” direction is carried out by the vehicle driver on the steering instrument 52 in the first deflection dimension determined for the tilting mechanism 100. This deflection of the steering instrument 52 corresponding to tilting outwards of the loading shovel 6 is transformed via a transformer into a second electric signal which is supplied to the electric adjusting magnet at the second control input 50 of the first-adjusting valve 41 via the electric line 53.

The actuated electric adjusting magnet at the second control input 50 leads to a deflection of the adjusting valve 41, so the second adjusting pressure chamber 38 of the first adjusting device 35 is connected to the high pressure side connection 24 of the first feed pump 19 via hydraulic line 42, 45 and 26 and the first adjusting pressure chamber 37 of the first adjusting device 35 is connected to the hydraulic tank 48 via hydraulic line 39 and 47. The adjusting piston 36 of the first adjusting device 35 is thereupon adjusted in the direction of a discharge volume at the first connection 14 of the adjustable first hydraulic pump 15.

This discharge volume at the first connection 14 of the adjustable first hydraulic pump 15 is supplied via the first hydraulic load line 13 to the piston rod side adjusting pressure chamber 5 of the second shovelling cylinder 2 and leads to a displacement of the adjusting piston 5 in the direction of the piston side adjusting pressure chamber 9. The higher adjusting pressure in the first hydraulic load line 13 is supplied via the hydraulic line 11 to the piston side adjusting pressure chamber 7 of the first shovelling cylinder 1, so the adjusting piston 3 is displaced in the direction of the piston rod side adjusting pressure chamber 8. Both the deflection of the adjusting piston 3 of the first shovelling cylinder 1 and the deflection of the adjusting piston 5 of the second shovelling cylinder 2 lead to a tilting outwards movement of the loading shovel 6.

If the vehicle driver intends to make a tilting inwards movement of the loading shovel 6, the steering instrument 52 is deflected in the “tilting inwards” direction in the first deflection dimension determined for the tilting mechanism 100. At the output 51 a first electric signal is generated by the transformer of the steering instrument 52 and supplied to the electric adjusting magnet at the first control input 49 of the first adjusting valve 41 via the electric line 59. The first adjusting valve 41 is actuated by the electric adjusting magnet at the first control input 49 in such a way that the first adjusting pressure chamber 37 of the first adjusting device 35 is connected to the high pressure side connection 24 of the first feed pump 19 via hydraulic lines 39, 45 and 26 and the second adjusting pressure chamber 38 of the first adjusting device 35 is connected to the hydraulic tank 48 via hydraulic lines 42 and 47. The adjusting piston 36 of the first adjusting device 35 is adjusted in the direction of a discharge volume or higher adjusting pressure at the second connection 17 of the adjustable first hydraulic pump 15.

This discharge volume at the second connection 17 of the adjustable first hydraulic pump 15 is conducted via the second hydraulic load line 16 into the piston side adjusting pressure chamber 9 of the second shovelling cylinder 2 and there leads to a deflection of the adjusting piston 5 in the direction of the piston rod side adjusting pressure chamber 10. The higher adjusting pressure in the second hydraulic load line 16 is supplied to the piston rod side adjusting pressure chamber 8 of the first shovelling cylinder 1 via the hydraulic line 12 and there leads to a deflection of the adjusting piston 3 in the direction of the piston side adjusting pressure chamber 7. The deflection of the adjusting piston 3 of the first shovelling cylinder 1 and also that of the adjusting piston 5 of the second shovelling cylinder 2 leads to a tilting inwards movement of the loading shovel 6.

In order to avoid the escape of hydraulic fluid from the adjusting pressure chambers 7 and 10 of the first and second shovelling cylinders 1 and 2 and therefore unintentional tilting inwards of the loading shovel 6 if the adjustable first hydraulic pump 15 fails, a switchable check valve 55 is switched in the first hydraulic load line 13. Via a transformer 57 and the electric line 56 the opener 58 of the switchable check valve 55 is connected to the transformer output 54 of the steering instrument 52. This guarantees that the check valve 55 is opened if the first and second shovelling cylinders 1 and 2 are supplied with a stream of hydraulic fluid of a specific adjusting pressure via the second hydraulic load line 16 on deflection of the steering instrument 52 in the “tilting inwards” direction in the first deflection dimension determined for the tilting mechanism 100 and is removed again within the framework of the closed circuit via the first hydraulic load line 13.

In FIG. 1B a circuit diagram of a hydraulic control and adjustment system for a lifting mechanism 200 of a working tool in a mobile machine is illustrated, consisting of a first lifting cylinder 61 and a second lifting cylinder 62. In the first lifting cylinder 61 an adjusting piston 63 is guided displaceably and mechanically coupled to the vehicle body 4. The first lifting cylinder 61 is mechanically connected to the boom 64, the angle of rotation of which relative to the vehicle body 4 fixes the lifting height of the loading shovel 6 arranged on its other end and its direction of rotation relative to the vehicle body 4 fixes the vertical direction of movement of the loading shovel 6. In the second lifting cylinder 62 the adjusting piston 65 is guided displaceably and connected to the loading shovel 6. The second lifting cylinder 62 is mechanically connected to the vehicle body 4.

The first lifting cylinder 1 has a piston side adjusting pressure chamber 67 and a piston rod side adjusting pressure chamber 68. The second lifting cylinder 62 likewise has a piston side adjusting pressure chamber 69 and a piston rod side adjusting pressure chamber 70. The piston side adjusting pressure chamber 67 of the first lifting cylinder 61 is connected to the piston rod side adjusting pressure chamber 69 of the second lifting cylinder 62 via a hydraulic line 71. In the same way the piston rod side adjusting pressure chamber 68 of the first lifting cylinder 61 is connected to the piston side adjusting pressure chamber 70 of the second lifting cylinder 62 via a hydraulic line 72.

The piston rod side adjusting pressure chamber 69 of the second lifting cylinder 62 or the piston side adjusting pressure chamber 67 of the first lifting cylinder 61 is connected to the first connection 74 of an adjustable second hydraulic pump 75 via a third hydraulic load line 73. The piston side adjusting pressure chamber 70 of the second lifting cylinder 62 or the piston rod side adjusting pressure chamber 68 of the first lifting cylinder 61 is connected to the second connection 77 of the adjustable second hydraulic pump 75 via a fourth hydraulic load line 76. The adjustable second hydraulic pump 75 is driven via a drive shaft 78 of a drive motor (not illustrated in FIG. 1B), for example a diesel aggregate corresponding to the drive motor for the drive shaft 16 of the first hydraulic pump 15.

In each case a first adjusting pressure chamber 8, 10 borders on the associated cylinder piston 3, 5 with a pressurisation face A1 which is smaller than the pressurisation face A2 with which the other second adjusting pressure chamber 7, 9 in each case borders on the corresponding cylinder piston 3, 5. Each connection 14, 17 of the hydraulic pump 15 is connected to a first adjusting pressure chamber 8 or 10 with a smaller pressurisation face A1 and a second adjusting pressure chamber 7 or 10 with a larger pressurisation face A2.

A second feed pump 79 is likewise driven via the drive shaft 78 by the drive motor. The second feed pump 79 is a hydraulic pump operating in single-quadrant operation, the low pressure side connection 80 of which is connected to a hydraulic tank 83 via a hydraulic line 81 with intermediate switching of a filter 82.

The high pressure side connection 84 of the second feed pump 79 is connected in respect of a pressure limitation to a pressure limiting valve 85 via a hydraulic line 86. One of the two control connections of the pressure limiting valve 85 is connected to the hydraulic line 86. At the other control input of the pressure limiting valve 85 a specific upper pressure limit value can be set via a spring 87. If the pressure in the hydraulic line 86 exceeds the upper pressure limit value set by the spring 87, the pressure limiting valve 85 opens and connects the hydraulic line 86 to the hydraulic tank 88. The pressure in hydraulic line 86 thereupon reduces until a pressure is set in the hydraulic line 86 corresponding to the upper pressure limit value and the pressure limiting valve 85 goes back into the closed state.

The high pressure side connection 84 of the second feed pump 79 is connected to a third check valve 89 and a fourth check valve 90 via hydraulic line 86. The third check valve 89 is connected with its second connection to the first hydraulic load line 73, while the fourth check valve 90 is connected with its second connection to the second hydraulic load line 76. If the pressure in the first hydraulic load line 73 drops below the pressure level fixed in hydraulic line 86 via the pressure limiting valve 85, the third check valve 89 opens and adapts the pressure in the first hydraulic load line 73 to the pressure prevailing in hydraulic line 86. Completely analogously, if there is a drop in pressure in the second hydraulic load line 76 below the pressure level prevailing in hydraulic line 86, the fourth check valve 90 opens and adapts the pressure in the second hydraulic load line 76 to the pressure prevailing in hydraulic line 86.

A pressure limiting valve 91 is switched parallel to the third check valve 89. This pressure limiting valve 91 compares the pressure value in the third hydraulic load line 73 applied at one of its control inputs with the theoretical pressure value set at the other control input via a spring 92 and opens if the pressure in the third hydraulic load line 73 exceeds the theoretical pressure value set by the spring 92. The pressure in the third hydraulic load line 73 is in this case reduced via the pressure limiting valve 91 into hydraulic line 86 until the pressure in the third hydraulic load line 73 corresponds to the theoretical pressure value set at the pressure limiting valve by the spring 92 and the pressure limiting valve 91 goes back into the closed state.

Analogously, a pressure limiting valve 93 is switched parallel to the fourth check valve 90. This compares the pressure prevailing in the fourth hydraulic load line 76, which is applied at one of its control inputs, with a theoretical pressure value set at its other control input by a spring 94 and opens if the pressure in the fourth hydraulic line 76 exceeds the theoretical pressure value set by the spring 94. The pressure in the fourth hydraulic load line 76 is in this case reduced via the pressure limiting valve 93 in hydraulic line 86 until the pressure in the fourth hydraulic load line 76 corresponds to the theoretical pressure value set by the spring 94 and the pressure limiting valve 93 goes back into the closed state.

Actuation of the adjustable second hydraulic pump 75 is done via a second adjusting device 95, the adjusting piston 96 of which is mechanically connected to the captive C-washer (not illustrated in FIG. 1) of the hydraulic pump 75. The adjusting piston 96 divides the second adjusting device 95 into a first adjusting pressure chamber 97 and a second adjusting pressure chamber 98. The first adjusting pressure chamber 97 is connected via a hydraulic line 99 to the first output 101 of an adjusting valve 102, configured as a 4/3 port directional control valve. The second adjusting pressure chamber 98 is connected to the second output 104 of the adjusting valve 102 via a hydraulic line 103. The first input 105 of the adjusting valve 102 is attached to the high pressure side connection 84 of the feed pump 79 via a hydraulic line 106 and hydraulic line 86. The second input 107 is connected to a hydraulic tank 109 via a hydraulic line 108.

Actuation of the second adjusting valve 102 is done via a first control input 110 and a second control input 111, both designed as electric adjusting magnets. Via an electric line 112 the electric adjusting magnet of the first control input 110 is connected to a third output 113 of a transformer (not illustrated in FIG. 1A or 1B), which transforms the mechanical deflection on a steering instrument 52 configured as a joystick (illustrated in FIG. 1) in the “lifting” direction in the second deflection dimension determined for the lifting mechanism 200 into a third electric signal corresponding thereto. The electric adjusting magnet of the second control input 111 is connected via an electric line 114 to a fourth output 115 of the transformer (not illustrated in FIG. 1A or 1B), which transforms the mechanical deflection on the steering instrument 52 in the “lowering” direction in the second deflection dimension determined for the lifting mechanism 200 into a fourth electric signal corresponding thereto.

If the vehicle driver intends to lower the loading shovel 6, a deflection in the “lowering” direction is carried out by the vehicle driver on the steering instrument 52 in the second deflection dimension determined for the lifting mechanism 200. This deflection of the steering instrument 52 corresponding to lowering the loading shovel 6 is transformed via a transformer into a fourth electric signal which is supplied to the electric adjusting magnet at the second control input 111 of the adjusting valve 102 via the electric line 114.

The actuated electric adjusting magnet at the second control input 111 leads to actuation of the adjusting valve 102, so the first adjusting pressure chamber 97 of the second adjusting device 95 is connected to the hydraulic tank 109 via hydraulic lines 99 and 106 and the second adjusting pressure chamber 98 of the second adjusting device 95 is connected to the high pressure side connection 84 of the second feed pump 79 via hydraulic lines 103, 106 and 86. The adjusting piston 96 of the adjusting device 95 is thereupon adjusted in the direction of a discharge volume or higher adjusting pressure at the first connection 74 of the adjustable second hydraulic pump 75.

This discharge volume at the first connection 74 of the adjustable second hydraulic pump 75 is supplied via the third hydraulic load line 73 to the piston rod side adjusting pressure chamber 69 of the second lifting cylinder 62 and leads to a displacement of the adjusting piston 65 in the direction of the piston side adjusting pressure chamber 70. The higher adjusting pressure in the third hydraulic load line 73 is supplied to the piston side adjusting pressure chamber 67 of the first lifting cylinder 61 via the hydraulic line 71, so the adjusting piston 63 is displaced in the direction of the piston rod side adjusting pressure chamber 68. Both the deflection of the adjusting piston 63 of the first lifting cylinder 61 and the deflection of the adjusting piston 65 of the second lifting cylinder 62 lead to a rotational movement of the boom 64 downwards relative to the vehicle body 4 and therefore to lowering of the loading shovel 6 relative to the vehicle body 4.

If the vehicle driver intends to lift the loading shovel 6, the steering instrument 52 is deflected in the “lifting” direction in the second deflection dimension determined for the lifting mechanism 200. At the output 113 a third electric signal is generated by the transformer of the steering instrument 52 (illustrated in FIG. 1A) and supplied to the electric adjusting magnet at the first control input 110 of the adjusting valve 102 via the electric line 112. The adjusting valve 102 is deflected by the electric adjusting magnet at the first control input 110 in such a way that the first adjusting pressure chamber 97 of the second adjusting device 95 is connected via hydraulic lines 99, 106 and 86 to the high pressure side connection 84 of the second feed pump 79 and the second adjusting pressure chamber 98 of the second adjusting device 95 is connected to the hydraulic tank 109 via hydraulic lines 103 and 108. The adjusting piston 96 of the second adjusting device 95 is adjusted in the direction of a discharge volume or higher adjusting pressure at the second connection 77 of the adjustable first hydraulic pump 75.

This discharge volume or this higher adjusting pressure at the second connection 77 of the adjustable second hydraulic pump 75 is conducted via the fourth hydraulic load line 76 into the piston side adjusting pressure chamber 70 of the second lifting cylinder 62 and there leads to a deflection of the adjusting piston 65 in the direction of the piston rod side adjusting pressure chamber 69. The higher adjusting pressure in the fourth hydraulic load line 76 is supplied to the piston rod side adjusting pressure chamber 68 of the first lifting cylinder 61 via the hydraulic line 72 and there leads to a deflection of the adjusting piston 63 in the direction of the piston side adjusting pressure chamber 67. The deflection of the adjusting piston 63 of the first lifting cylinder 61 and also that of the adjusting piston 65 of the second lifting cylinder 62 lead to a rotational movement of the boom 64 upwards relative to the vehicle body 4 and therefore to lifting of the loading shovel 6 relative to the vehicle body 4.

In order to avoid escape of the hydraulic fluid from the adjusting pressure chambers 68 and 70 of the first and second lifting cylinders 61 and 62 and therefore unintentional lowering of the boom 64 and therefore of the loading shovel 6 if the adjustable second hydraulic pump 75 fails, a check valve 116 is switched in the fourth hydraulic load line 73. Via a transformer 117 and an electric line 118 the opener 129 of the switchable check valve 116 is connected to the transformer output 115 of the steering instrument 52. This guarantees that the check valve 116 is opened if during deflection of the steering instrument 52 in the “lowering” direction in the second deflection dimension determined for the lifting mechanism 200 the first and second lifting cylinders 61 and 62 are supplied with a stream of hydraulic fluid of a specific adjusting pressure via the third hydraulic load line 73 and this is removed again within the framework of the closed circuit via the fourth hydraulic load line 76.

If the vehicle driver intends to level the plane simply by the force of weight of the loading shovel resting on the plane—without the application of an adjusting pressure specifically generated by the working hydraulics —(“floating position” of the loading shovel 6), a 2/2 port directional control valve 119 located between the third and fourth hydraulic load lines 73 and 76 is opened via an electric or hydraulic control signal at the second control input 121. This electric or hydraulic control signal is generated after a switch 120 has been closed by the vehicle driver when intending to level the plane by an electric transformer (not illustrated in FIG. 1B) arranged on the switch 120 or by a hydraulic adjusting valve (not illustrated in FIG. 1B) and supplied to the second control input 121 via the electric or hydraulic line 122. When the switch 120 is open the 2/2 port directional control valve 119 is switched into the closed state by the spring 124 attached to the first control input 123, in which state there is no hydraulic connection between the third and fourth hydraulic load lines 73 and 76.

Occurring pitching oscillations, in particular of the full loading shovel 6 while the mobile machine is travelling at a higher speed of travel, are damped by a hydraulic control arrangement 125. For this a signal from the vehicle's tachogenerator 126, corresponding to the travelling speed of the mobile machine, is conducted to the input 127 of the hydraulic control arrangement 125. If the travelling speed is above a specific value and if a stop valve inside the hydraulic control arrangement 125 is opened by the vehicle driver via a key button, the adjusting pressure chambers 68 and 70 of the lifting cylinders 61 and 62 are cleared for lifting the loading shovel 6 via hydraulic load line 73, hydraulic line 128 and the open stop valve to a hydraulic store inside the hydraulic control arrangement 125. This hydraulic store is loaded via a pressure reducing valve inside the hydraulic control arrangement 125 by the second hydraulic pump 75 to the expected load pressure in the lifting cylinders 61 and 62. Sagging of the loading shovel 6 when the hydraulic control arrangement 125 is cleared for damping the pitching oscillations of the loading shovel 6 is thus minimised. More precise details of the functional construction or the mode of operation of the hydraulic control arrangement 125 for damping pitching oscillations of the loading shovel 6 when the mobile machine is travelling can be found in DE 41 29 509 C2, the content of which is incorporated into the present application.

By contrast with the first embodiment of the hydraulic control and adjustment system according to the invention for a tilting mechanism 100 in FIG. 1A and for a lifting mechanism 200 in FIG. 1B, in which electric actuation of the first and second adjusting valves 41 and 102 is implemented, in FIGS. 2A and 2B a second embodiment of the hydraulic control and adjustment system according to the invention for a tilting mechanism 100 and a lifting mechanism 200 with hydraulic actuation of the first and second adjusting valves 41 and 102 is illustrated. For the sake of uniformity in FIGS. 2A and 2B identical reference symbols to FIGS. 1A and 1B are used for the same components.

Instead of the electric adjusting magnets the first control input 49 and the second control input 50 of the first adjusting valve 41 and the first control input 110 and the second control input 111 of the second adjusting valve 102 have in each case an adjusting pressure chamber for hydraulic actuation of the first and second adjusting valves 41 and 102. The adjusting pressure chamber of the first control input 49 of the first adjusting valve 41 is supplied from the pressure at the first output 129 of the pilot control device 130 via the hydraulic line 51. The adjusting pressure chamber of the second control input 50 of the first adjusting valve 41 is supplied from the pressure at the second output 131 of the pilot control device 130 via the hydraulic line 53. The adjusting pressure chamber of the first control input 110 of the second adjusting valve 102 is supplied from the pressure at the third output 132 of the pilot control device 130 via the hydraulic line 112. The adjusting pressure chamber of the second control input 111 of the second adjusting valve 102 is supplied from the pressure at the fourth output 133 of the pilot control device 130 via the hydraulic line 114.

The first input 134 of the pilot control device 130 is attached to the high pressure side connection 24 of the first feed pump 19 via a hydraulic line 135. The second input 136 of the pilot control device 130 is connected to a hydraulic tank 138 via a hydraulic line 137.

The first and second adjusting pressure applied at the first and second outputs 129 and 131 for actuating the first adjusting valve 41 can be set via the two pressure reducing valves 139 and 140 of a first pair of pressure reducing valves 143, the two inputs of which are connected in each case to the first and second inputs 134 and 136 of the pilot control device 130, via a deflection of the steering instrument 52 configured as a joystick in the first deflection dimension determined for the lifting mechanism 100. For this the mechanical deflection of the steering instrument 52 is conducted in the first deflection dimension to one of the two control inputs of the two pressure reducing valves 139 and 140.

In the ratio of the difference in pressure between the control pressure produced by the deflection of the steering instrument 52 in the first deflection dimension at one of the two control inputs of the pressure reducing valve 139 and the first adjusting pressure conducted to the other control input of the pressure reducing valve 139 at the first output 129 of the pilot control device 130, a proportional pressure between the pressures applied at the first and second inputs 134 and 136 of the pilot control device 130 is switched through by the pressure reducing valve 139 to the first output 129 of the pilot control device 130.

Analogously, in the ratio of the difference in pressure between the control pressure produced by the deflection of the steering instrument 52 in the first deflection dimension at one of the two control inputs of the pressure reducing valve 140 and the second adjusting pressure conducted to the other control input of the pressure reducing valve 140 at the second output 131 of the pilot control device 130 by the pressure reducing valve 140, a proportional pressure between the pressures applied at the first and second inputs 134 and 136 of the pilot control device 130 is switched through to the second output 131 of the pilot control device 130.

The third and fourth adjusting pressure applied at the third and fourth outputs 132 and 133 for actuating the second adjusting valve 102 are set via the two pressure reducing valves 141 and 142 of a second pair of pressure reducing valves 144, the two inputs of which are connected in each case to the first and second inputs 134 and 136 of the pilot control device 130, via a deflection of the steering instrument 52, configured as a joystick, in the second deflection dimension determined for the lifting mechanism 200. For this the mechanical deflection of the steering instrument 52 is conducted in the second deflection dimension to one of the two control inputs of the two pressure reducing valves 141 and 142.

In the ratio of the difference in pressure between the control pressure produced by the deflection of the steering instrument 52 in the second deflection dimension at one of the two control inputs of the pressure reducing valve 141 and the third adjusting pressure conducted to the other control input of the pressure reducing valve 141 at the third output 132 of the pilot control device 130, a proportional pressure between the pressures applied at the first and second inputs 134 and 136 of the pilot control device 130 is switched through to the third output 132 of the pilot control device 130 by the pressure reducing valve 141.

Analogously, in the ratio of the difference in pressure between the control pressure produced by the deflection of the steering instrument 52 in the second deflection dimension at one of the two control inputs of the pressure reducing valve 142 and the fourth adjusting pressure conducted to the other control input of the pressure reducing valve 142 at the fourth output 133 of the pilot control device 130 a proportional pressure between the pressures applied at the first and second inputs 134 and 136 of the pilot control device 130 is switched through to the fourth output 133 of the pilot control device 130 by the pressure reducing valve 142.

The mode of operation of the adjustment of the adjustable first and second hydraulic pumps 15 and 75 are actuated via the first and second adjusting devices 35 or 95, which are actuated by the first or second adjusting valve 41 or 102 and the mode of operation of the shovelling and lifting cylinder arrangement in the second embodiment of the hydraulic control and adjustment system according to the invention for a tilting mechanism 100 and a lifting mechanism 200 corresponds to the mode of operation of the corresponding components in the first embodiment of the control and adjustment system according to the invention for a tilting mechanism 100 and a lifting mechanism 200, so repeated description of this mode of operation is dispensed with at this point.

A special feature of the embodiment example illustrated in FIGS. 2A and 2B compared with the embodiment example illustrated in FIGS. 1A and 1B is also that there is a pressure cut-off 163. The pressure cut-off 163 consists of the shuttle valve 160 and the pressure limiting valve 161. The shuttle valve 160 is connected to the load lines 13 and 16 or 73 and 76 and in each case selects the higher load pressure in the two load lines 13 and 16 or 73 and 76. This acts as control pressure for the pressure limiting valve 161. If the pressure in the load line 13 or 16 or 73 or 76 conducting the higher load pressure rises above a threshold value presettable by the spring 164, the pressure limiting valve 161 opens and the pressure in the hydraulic line 45 or 106 is reduced. In this way the hydraulic pump 15 or 75 swivels back to a smaller discharge volume.

This function is advantageous for avoiding permanent activation of the pressure limiting valves 31, 33 or 91, 93 if the adjusting pistons 3, 5 or 63, 65 run against their limit stop position. In this case the load pressure would increase significantly when the end stop was reached, thus activating the pressure limiting valves 31, 33 or 91, 93 and discharging the load pressure into the tank while generating heat. This is not effective, since the hydraulic fluid is unnecessarily heated and the hydraulic pump 15 or 75 performs unnecessary work. It is therefore more sensible on reaching the end stop position to swivel the hydraulic pump 15 or 75 back.

In FIG. 3A the shovelling cylinder hydraulics of a third embodiment of a hydraulic control and adjustment system according to the invention for a working tool in a mobile machine are illustrated, in which in the first and second shovelling cylinders 1 and 2 in each case an adjusting piston 130 and 131 with a two-sided piston rod is displaceable.

The adjusting piston 130 is guided movably with its loading shovel side piston rod through a recess 138 in the first shovelling cylinder 1 and in the loading shovel 138 and with its vehicle body side piston rod through a recess 139 in the first shovelling cylinder 1 and is mechanically connected with its vehicle body side end to the vehicle body 4.

The adjusting piston 131 is, according to an alternative configuration, guided movably with its loading shovel side piston rod through a recess 140 in the second shovelling cylinder 2, on its loading shovel side end mechanically connected to the loading shovel 6 and with its vehicle body side piston rod guided movably through a recess 141 of the second shovelling cylinder 2.

The length of the loading shovel side piston rod of the adjusting piston 130 is dimensioned in such a way that the adjusting piston 130 is in contact with the recess 138 at any given adjusting pressure level in the first hydraulic load line 13. Analogously, the length of the vehicle body side piston rod of the adjusting piston 131 is dimensioned in such a way that the adjusting piston 131 is in contact with the recess 141 in the second hydraulic load line 16 at any given adjusting pressure level.

The first shovelling cylinder 1 is mechanically connected at its loading shovel side end to the loading shovel 6. The second shovelling cylinder 2 is mechanically connected with its vehicle body side end to the vehicle body 4 in such a way that the adjusting piston 131 does not come into contact with the vehicle body 4 in the second shovelling cylinder 2 during any given deflection.

The displaceable adjusting piston 130 separates the first shovelling cylinder 1 into a loading shovel side adjusting chamber 132 and a vehicle body side adjusting pressure chamber 133. Analogously the displaceable adjusting piston 131 separates the second shovelling cylinder 2 into a loading shovel side adjusting chamber 134 and a vehicle body side adjusting pressure chamber 135. The two loading shovel side adjusting pressure chambers 132 and 134 are connected to one another via a hydraulic line 136 and the vehicle body side adjusting pressure chambers 133 and 135 via a hydraulic line 137. The two loading shovel side adjusting pressure chambers 132 and 134 are connected to the first connection 14 of the first hydraulic pump 15 via the first hydraulic load line 13. The two vehicle body side adjusting pressure chambers 133 and 135 are connected to the second connection 17 of the first hydraulic pump 15 via the second hydraulic load line 16.

The mode of operation of the further embodiment of the shovelling cylinder hydraulics in FIG. 3A corresponds to the mode of operation of the first embodiment of the shovelling cylinder hydraulics in FIG. 1A, so detailed description of this can be dispensed with. The shovelling cylinder hydraulics in FIG. 3A differ from the shovelling cylinder hydraulics in FIG. 1A only in the possibility of parallel circuitry of the shovelling cylinders 1 and 2 on the basis of identical expansion and compression volumes in the two adjusting pressure chambers 132 and 133 or 134 and 135.

In FIG. 3B lifting cylinder hydraulics are illustrated in a third embodiment of a hydraulic control and adjustment system according to the invention for a working tool in a mobile machine, in which in the first and second lifting cylinders 61 and 62 in each case an adjusting piston 142 and 143 with a two-sided piston rod is displaceable.

The adjusting piston 142 is guided movably with its boom side piston rod through a recess 148 in the first lifting cylinder 61 and in the boom 64 and with its vehicle body side piston rod through a recess 149 in the first lifting cylinder 61 and with its vehicle body side end is mechanically connected to the vehicle body 4.

The adjusting piston 143 is, according to an alternative configuration, guided movably with its boom side piston rod through a recess 150 in the second lifting cylinder 62, on its boom side end mechanically connected to the boom 64 and with its vehicle body side piston rod guided movably through a recess 151 of the second lifting cylinder 62.

The length of the loading shovel side piston rod of the adjusting piston 142 is dimensioned in such a way that the adjusting piston 142 is in contact with the recess 148 at any given adjusting pressure level in the third hydraulic load line 73. Analogously the length of the vehicle body side piston rod of the adjusting piston 143 is dimensioned in such a way that the adjusting piston 143 is in contact with the recess 151 at any given adjusting pressure level in the fourth hydraulic load line 76. The length of the recess 151 in the fourth lifting cylinder 62 is dimensioned in such a way that the adjusting piston 143 does not come into contact with the vehicle body 4 in any given adjusting pressure conditions in the third and fourth hydraulic load lines 73 and 76.

The first lifting cylinder 61 is mechanically connected to the boom 64 at its boom side end. The second lifting cylinder 62 is mechanically connected to the vehicle body 4 with its vehicle body side end in such a way that the adjusting piston 143 does not come into contact with the vehicle body 4 in the second lifting cylinder 62 in any deflection.

The displaceable adjusting piston 142 separates the first lifting cylinder 61 into a boom side adjusting chamber 144 and a vehicle body side adjusting pressure chamber 145. Analogously the displaceable adjusting piston 143 separates the second lifting cylinder 62 into a boom side adjusting pressure chamber 146 and a vehicle body side adjusting pressure chamber 147. The two boom side adjusting pressure chambers 144 and 146 are connected to one another via a hydraulic line 151 and the vehicle body side adjusting pressure chambers 145 and 147 via a hydraulic line 152. The two boom side adjusting pressure chambers 145 and 146 are connected to the first connection 74 of the second hydraulic pump 75 via the third hydraulic load line 73. The two vehicle body side adjusting pressure chambers 145 and 146 are connected to the second connection 77 of the second hydraulic pump 75 via the fourth hydraulic load line 76.

The mode of operation of the further embodiment of the lifting cylinder hydraulics in FIG. 3B corresponds to the mode of operation of the first embodiment of the lifting cylinder hydraulics in FIG. 1B, so a detailed description of this is dispensed with. The lifting cylinder hydraulics in FIG. 3B differ from the lifting cylinder hydraulics in FIG. 1B only in the possibility of parallel circuitry of the lifting cylinders 61 and 62 on the basis of identical expansion and compression volumes in the two adjusting pressure chambers 144 and 145 or 146 and 147.

1. Lifting mechanism with a hydraulic control and adjustment system and a working tool in a mobile machine with at least a first and second lifting cylinder, in which cylinder pistons are displaceable, the position or direction of movement of which in the lifting cylinders fix the lifting height or the vertical direction of movement of the working tool relative to a vehicle body of the mobile machine, wherein each of the cylinder pistons divides the associated lifting cylinder into two adjusting pressure chambers in each case and with a first hydraulic pump, adjustable in respect of the discharge volume, the first connection of which is connected depending on the vertical direction of movement of the working tool to one of the adjusting pressure chambers of the first lifting cylinder and one of the adjusting pressure chambers of the second lifting cylinder and the second connection of which is connected in a closed circuit to the other adjusting pressure chamber of the first lifting cylinder and the other adjusting pressure chamber of the second lifting cylinder,
wherein a piston side adjusting pressure chamber of the first lifting cylinder is connected to a piston rod side adjusting pressure chamber of the second lifting cylinder via a first hydraulic line and a piston rod side adjusting pressure chamber of the first lifting cylinder is connected to a piston side adjusting pressure chamber of the second lifting cylinder via a second hydraulic line and the first lifting cylinder and the adjusting piston of the second lifting cylinder are connected to a boom connecting the working tool to the vehicle body of the mobile machine and the second lifting cylinder and the adjusting piston of the first lifting cylinder are connected to the body of the mobile machine.

2. Lifting mechanism according to claim 1,
wherein in each case a first adjusting pressure chamber borders on the associated cylinder piston with a pressurisation face (A1) which is smaller than the pressurisation face (A2) with which the other second adjusting pressure chamber in each case borders on the corresponding cylinder piston and in that each connection of the hydraulic pump is connected to a first adjusting pressure chamber with a smaller pressurisation face (A1) and a second adjusting pressure chamber with a larger pressurisation face (A2).

3. Lifting mechanism according to claim 1,
wherein the two boom side adjusting pressure chambers of the first and second lifting cylinders are connected via a first hydraulic line and the two vehicle body side adjusting pressure chambers of the first and second lifting cylinders via a second hydraulic line.

4. Tilting mechanism with a hydraulic control and adjustment system and with a loading shovel serving as a working tool in a mobile machine with at least a first and second shovelling cylinder, in which cylinder pistons are displaceable, the position or direction of movement of which in the shovelling cylinders fix the tilting angle or the tilting direction of the loading shovel relative to a vehicle body, wherein each of the cylinder pistons divides the associated shovelling cylinder into two adjusting pressure chambers in each case, and with a second hydraulic pump, adjustable in respect of the discharge volume, the first connection of which is connected depending on the tilting direction of the loading shovel to one of the adjusting pressure chambers of the first shovelling cylinder and one of the adjusting pressures chambers of the second shovelling cylinder and the second connection of which is connected in a closed circuit to the other adjusting pressure chamber of the first shovelling cylinder and the other adjusting pressure chamber of the second shovelling cylinder,
wherein the piston side adjusting pressure chamber of the first shovelling cylinder is connected to the piston rod side adjusting pressure chamber of the second shovelling cylinder via a first hydraulic line and the piston rod side adjusting pressure chamber of the first shovelling cylinder is, connected to the piston side adjusting pressure chamber of the second shovelling cylinder via a second hydraulic line and the first shovelling cylinder and the adjusting piston of the second shovelling cylinder are connected to the loading shovel and the second shovelling cylinder and the adjusting piston of the first shovelling cylinder are connected to the body of the mobile machine.

5. Tilting mechanism according to claim 4,
wherein in each case a first adjusting pressure chamber borders on the associated cylinder piston with a pressurisation face (A1) which is smaller than the pressurisation face (A2) with which the other second adjusting pressure chamber in each case borders on the corresponding cylinder piston and in that each connection of the hydraulic pump is connected to a first adjusting pressure chamber with a smaller pressurisation face (A1) and a second adjusting pressure chamber with a larger pressurisation face (A2).

6. Tilting mechanism according to claim 4.
wherein the two loading shovel side adjusting pressure chambers of the first and second shovelling cylinders are connected via a first hydraulic line and the two vehicle body side adjusting pressure chambers of the first and second shovelling cylinders via a second hydraulic line.

7. Lifting mechanism according to claim 1,
wherein the discharge direction of the first hydraulic pump operating in two-quadrant operation fixes the vertical direction of movement of the working tool or the discharge direction of the second hydraulic pump, likewise operating in two-quadrant operation, fixes the tilting direction of the loading shovel.

8. Lifting mechanism according to claim 1,
wherein the discharge volume discharged at the first and second connections of the first hydraulic pump fixes the lifting height of the working tool or the discharge volume discharged at the first and second connection of the second hydraulic pump fixes the tilting angle of the loading shovel.

9. Lifting mechanism according to claim 8,
wherein the adjustment of the discharging device of the second hydraulic pump and the discharge volume discharged at the first and second connections of the second hydraulic pump is done as a function of a deflection set on a steering instrument constructed in the manner of a joystick in a first deflection dimension and the setting of the direction of rotation of the first hydraulic pump and the adjusting pressure built up at the first and second connections of the first hydraulic pump is done as a function of a deflection set on the steering instrument constructed in the manner of a joystick in a second deflection dimension.

10. Lifting mechanism according to claim 9,
wherein a first adjusting valve is actuated as a function of the deflection of the steering instrument in the first deflection dimension and a second adjusting valve is actuated as a function of the deflection of the steering instrument in the second deflection dimension.

11. Lifting mechanism according to claim 10,
wherein the deflection of the first adjusting valve is done by electric adjusting magnets on control connections of the first adjusting valve, wherein one control connection receives a first electric signal, corresponding to the deflection of the steering instrument in the direction of the first deflection dimension, corresponding to the tilting inwards movement, and the other control connection receives a second electric signal, corresponding to the deflection of the steering instrument in the direction of the first deflection dimension, corresponding to the tilting outwards movement, from a transformer of the steering instrument and in that the deflection of the second adjusting valve is done by electric adjusting magnets at control connections of the second adjusting valve, wherein one control connection receives a third electric signal, corresponding to the deflection of the steering instrument in the direction of the second deflection dimension, corresponding to the lifting movement, and the other control connection receives a fourth electric signal, corresponding to the deflection of the steering instrument in the direction of the second deflection dimension, corresponding to the lowering movement, from a transformer of the steering instrument.

12. Lifting mechanism according to claim 10,
wherein the deflection of the first adjusting valve is done by adjusting pressures generated by a pilot control device from the deflection of the steering instrument in the first deflection dimension and supplied to control chambers located at the two control connections of the first adjusting valve and the deflection of the second adjusting valve is done by adjusting pressures generated by the pilot control device from the deflection of the steering instrument in the second deflection dimension and supplied to control chambers located at the two control connections of the second adjusting valve.

13. Lifting mechanism according to claim 12,
wherein via a first pair of pressure reducing valves consisting of two pressure reducing valves the inputs of which are connected in each case to a high pressure side connection of a first feed pump, and a hydraulic tank which generates adjusting pressures corresponding to the deflection of the steering instrument in the two directions of the first deflection dimension, the pilot control device generates corresponding adjusting pressures for actuating the first adjusting valve and via a second pair of pressure reducing valves, consisting of two pressure reducing valves, the inputs of which are connected in each case to a high pressure side connection of a first feed pump and a first hydraulic tank which generates adjusting pressures corresponding to the deflection of the steering instrument in the two directions of the second deflection dimension for the second adjusting valve.

14. Lifting mechanism according to claim 10,
wherein the first and second adjusting valve is in each case a 4/3 port directional control valve, wherein the first input connection of the first adjusting valve is connected to the high pressure side connection of the first feed pump, the first input connection of the second adjusting valve is connected to a high pressure side connection of a second feed pump, the second input connection of the first and second adjusting valves is connected in each case to a hydraulic tank, the first output connection of the first adjusting valve is connected to a first adjusting pressure chamber of a first adjusting device, the first output connection of the second adjusting valve is connected to a first adjusting pressure chamber of a second adjusting device, the second output connection of the first adjusting valve is connected to a second adjusting pressure chamber of a first adjusting device and the second out put connection of the second adjusting valve is connected to a second adjusting pressure chamber of a second adjusting device.

15. Lifting mechanism according to claim 14,
wherein adjustment of the second hydraulic pump in respect of the discharge direction and the discharge volume discharged at the first and second connection is done by the first adjusting device and adjustment of the first hydraulic pump in respect of the discharge direction and the discharge volume discharged at the first and second connections by the second adjusting device.

16. Lifting mechanism according to claim 13,
wherein the second hydraulic pump and the first feed pump or the first hydraulic pump and the second feed pump are driven by a common shaft in each case of a common or in each case separate machine, in particular by a diesel aggregate.

17. Lifting mechanism according to claim 13,
wherein a low pressure side connection of the first feed pump is connected via a filter to a hydraulic tank, a low pressure side connection of the second feed pump via a filter to a hydraulic tank, the high pressure side connection of the first feed pump via a check valve in each case to a first hydraulic load line attached to a first connection of the second hydraulic pump and to a second hydraulic load line attached to a second connection of the second hydraulic pump and the high pressure side connection of the second feed pump via a check valve in each case to a third hydraulic load line attached to a first connection of the first hydraulic pump and to a fourth hydraulic load line attached to a second connection of the first hydraulic pump.

18. Lifting mechanism according to claim 17,
wherein a check valve with an opener is provided in the first and third hydraulic load lines in each case.

19. Lifting mechanism according to claim 18,
wherein after transformation into a corresponding pressure, the second electric adjusting signal actuates an opener of the check valve integrated in the first hydraulic load line (13) and, after transformation into a corresponding pressure, the fourth electric adjusting signal actuates an opener of the check valve integrated in the third hydraulic load line.

20. Lifting mechanism according to claim 17,
wherein the second adjusting pressure generated by the pilot control device actuates an opener of the check valve integrated in the first hydraulic load line and the fourth adjusting pressure generated by the pilot control device actuates an opener of the check valve integrated in the third hydraulic load line.

21. Lifting mechanism according to claim 17,
wherein located between the third and fourth hydraulic load lines is a 2/2 port directional control valve which opens in the operating state “floating position” of the boom by applying an electric signal to an electric adjusting magnet located at the control input of the 2/2 port directional control valve or alternately by applying an adjusting pressure in a control chamber located at the control input of the 2/2 port directional control valve.

22. Lifting mechanism according to claim 17,
wherein the third hydraulic load line is connected via a hydraulic line to a hydraulic control arrangement to damp pitching oscillations of the working tool while the mobile machine is travelling.

23. Lifting mechanism according to claim 22,
wherein an electric signal corresponding to the speed of the mobile machine is conducted from a tachogenerator of the mobile machine to the input of the hydraulic control arrangement to damp pitching oscillations of the working tool while the mobile machine is travelling.

24. Tilting mechanism according to claim 4, wherein the discharge direction of the first hydraulic pump operating in two-quadrant operation fixes the vertical direction of movement of the working tool or the discharge direction of the second hydraulic pump, likewise operating in two-quadrant operation, fixes the tilting direction of the loading shovel.

25. Tilting mechanism according to claim 4, wherein the discharge volume discharged at the first and second connections of the first hydraulic pump fixes the lifting height of the working tool or the discharge volume discharged at the first and second connection of the second hydraulic pump fixes the tilting angle of the loading shovel.

26. Tilting mechanism according to claim 25, wherein the adjustment of the discharging device of the second hydraulic pump and the discharge volume discharged at the first and second connections of the second hydraulic pump is done as a function of a deflection set on a steering instrument constructed in the manner of a joystick in a first deflection dimension and the setting of the direction of rotation of the first hydraulic pump and the adjusting pressure built up at the first and second connections of the first hydraulic pump is dome as a function of a deflection set on the steering instrument constructed in the manner of a joystick in a second deflection dimension.

27. Tilting mechanism according to claim 26, wherein a first adjusting valve is actuated as a function of the deflection of the steering instrument in the first deflection dimension and a second adjusting valve is actuated as a function of the deflection of the steering instrument in the second deflection dimension.

28. Tilting mechanism according to claim 27, wherein the deflection of the first adjusting valve is done by electric adjusting magnets on control connections of the first adjusting valve, wherein one control connection receives a first electric signal, corresponding to the deflection of the steering instrument in the direction of the first deflection dimension, corresponding to the tilting inwards movement, and the other control connection receives a second electric signal, corresponding to the deflection of the steering instrument in the direction of the first deflection dimension, corresponding to the tilting outwards movement, from a transformer of the steering instrument and in that the deflection of the second adjusting valve is done by electric adjusting magnets at control connections of the second adjusting valve, wherein one control connection receives a third electric signal, corresponding to the deflection of the steering instrument in the direction of the second deflection dimension, corresponding to the lifting movement, and the other control connection receives a fourth electric signal, corresponding to the deflection of the steering instrument in the direction of the second deflection dimension, corresponding to the lowering movement, from a transformer of the steering instrument.

29. Tilting mechanism according to claim 27, wherein the deflection of the first adjusting valve is done by adjusting pressures generated by a pilot control device from the deflection of the steering instrument in the first deflection dimension and supplied to control chambers located at the two control connections of the first adjusting valve and the deflection of the second adjusting valve is done by adjusting pressures generated by the pilot control device from the deflection of the steering instrument in the second deflection dimension and supplied to control chambers located at the two control connections of the second adjusting valve.

30. Tilting mechanism according to claim 29, wherein via a first pair of pressure reducing valves consisting of two pressure reducing valves, the inputs of which are connected in each case to a high pressure side connection of a first feed pump, and a hydraulic tank which generates adjusting pressures corresponding to the deflection of the steering instrument in the two directions of the first deflection dimension, the pilot control device generates corresponding adjusting pressures for actuating the first adjusting valve and via a second pair of pressure reducing valves, consisting of two pressure reducing valves, the inputs of which are connected in each case to a high pressure side connection of a first feed pump and a first hydraulic tank which generates adjusting pressures corresponding to the deflection of the steering instrument in the two directions of the second deflection dimension for the second adjusting valve.

31. Tilting mechanism according to claim 27, wherein the first and second adjusting valve is in each case a 4/3 port direction control valve, wherein the first input connection of the first adjusting valve is connected to the high pressure side connection of the first feed pump, the first input connection of the second adjusting valve is connected to a high pressure side connection of a second feed pump, the second input connection of the first and second adjusting valves is connected in each case to a hydraulic tank, the first output connection of the first adjusting valve is connected to a first adjusting pressure chamber of a first adjusting device, the first output connection of the second adjusting valve is connected to a first adjusting pressure chamber of a second adjusting device, the second output connection of the first adjusting valve is connected to a second adjusting pressure chamber of a first adjusting device and the second out put connection of the second adjusting valve is connected to a second adjusting pressure chamber of a second adjusting device.

32. Tilting mechanism according to claim 28, wherein adjustment of the second hydraulic pump in respect of the discharge direction and the discharge volume discharged at the first and second connection is done by the first adjusting device and adjustment of the first hydraulic pump in respect of the discharge direction and the discharge volume discharged at the first and second connections by the second adjusting device.

33. Tilting mechanism according to claim 30, wherein the second hydraulic pump and the first feed pump or the first hydraulic pump and the second feed pump are driven by a common shaft in each case of a common or in each case separate machine, in particular by a diesel aggregate.

34. Tilting mechanism according to claim 30, wherein a low pressure side connection of the first feed pump is connected via a filter to a hydraulic tank, a low pressure side connection of the second feed pump via a filter to a hydraulic tank, the high pressure side connection of the first feed pump via a check valve in each case to a first hydraulic load line attached to a first connection of the second hydraulic pump and to a second hydraulic load line attached to a second connection of the second hydraulic pump and the high pressure side connection of the second feed pump via a check valve in each case to a third hydraulic load line attached to a first connection of the first hydraulic pump and to a fourth hydraulic load line attached to a second connection of the first hydraulic pump.

35. Tilting mechanism according to claim 34, wherein a check valve with an opener is provided in the first and third hydraulic load lines in each case.

36. Tilting mechanism according to claim 35, wherein after transformation into a corresponding pressure, the second electric adjusting signal actuates an opener of the check valve integrated in the first hydraulic load line and, after transformation into a corresponding pressure, the fourth electric adjusting signal actuates an opener of the check valve integrated in the third hydraulic load line.

37. Tilting mechanism according to claim 34, wherein the second adjusting pressure generated by the pilot control device actuates an opener of the check valve integrated in the first hydraulic load line and the fourth adjusting pressure generated by the pilot control device actuates an opener of the check valve integrated in the third hydraulic load line.

38. Tilting mechanism according to claim 34, wherein located between the third and fourth hydraulic load lines is a 2/2 port directional control valve which opens in the operation state “floating position” of the boom by applying an electric signal to an electric adjusting magnet located at the control input of the 2/2 port directional control valve or alternately by applying an adjusting pressure in a control chamber located at the control input of the 2/2 port directional control valve.

39. Tilting mechanism according to claim 34, wherein the third hydraulic load line is connected via a hydraulic line to a hydraulic control arrangement to damp pitching oscillations of the working tool while the mobile machine is travelling.

40. Tilting mechanism according to claim 39, wherein an electric signal corresponding to the speed of the mobile machine is conducted from a tachogenerator of the mobile machine to the input of the hydraulic control arrangement to damp pitching oscillations of the working tool while the mobile machine is travelling.
